(19) United States
(12) Patent Application Publication
(10) Pub. No.: US 2002/0124811 A1
(43) Pub. Date: Sep. 12, 2002

(54) Spherical and spherical polyhedral skeletal animal toys

(76) Inventors: Jonathan Willinger, Tenafly, NJ (US); Karen O. Winkler, Bethlehem, PA (US)

Correspondence Address: Helfgott & Karas, P.C., Empire State Building, 60th Floor, New York, NY, 10118, US

(21) Appl. No.: 09/847,564

(22) Filed: May 2, 2001

Related U.S. Application Data
(60) Provisional application No. 60/265,197, filed on Jan. 31, 2001.

(51) Int. Cl. A01K 29/00

(52) U.S. Cl. 119/707

(57) ABSTRACT

Skeletal animal toys capable of rolling and bouncing comprise polyhedra or other skeletal structures which can be inscribed on an imaginary spherical or ellipsoidal surface, torii and linear members which form a cylinder with circular cross-section, or elliptical and linear members which form a cylinder with elliptical cross-section. The skeletal animal toy is formed of an elastomeric material which is preferably natural rubber, synthetic natural rubber, or a blend of natural rubber or synthetic natural rubber and one of a plurality of blending polymers including butadiene rubber, styrene-butadiene rubber, nitrile rubber and ethylene-propylene-diene-monomer rubber.

### CROSS-REFERENCE TO RELATED APPLICATION

This application claims the benefit of U.S. Provisional Application No. 60/265197, filed on Jan. 31, 2001.

### BACKGROUND OF THE INVENTION

1. Field of the Invention

This invention relates to the field of animal toys and more specifically, to hollow rollable animal toys.

2. Description of the Related Art

Although many animal toys exist in various shapes and sizes, it is particularly desirable to produce animal toys having a skeletal structure and able to roll and bounce. The skeletal structure of the toy will allow the animal to grasp the toy with its teeth and will substantially lighten the toy, while the capability of rolling and bouncing increases the attractiveness of the toy to the animal. The capability of rolling dictates that the skeletal structure form a sphere, a cylinder, or a shape that is substantially spherical or cylindrical. The requirement that the toy bounce indicates that it must be made of some elastomeric material. If however, the skeletal structure is to be made spherical in nature or even in the form of a cylinder, the problem presents itself of extracting the mold on which the skeletal structure is formed from the inside of the skeletal structure after the skeletal structure is formed.

### SUMMARY OF THE INVENTION

The present invention comprises a substantially spherical or cylindrical skeletal structure made of natural rubber which is capable of rolling and bouncing. Rubber is chosen for the skeletal structure since it will stretch enough when hot and newly formed to allow the internal mold to be pulled out of the skeletal structure, in contrast with synthetic elastomers which may not have the requisite elasticity to allow extraction of the internal mold after forming of the skeletal structure. Furthermore, natural rubber has superior tear resistance when compared to the tear resistance of synthetic elastomers which is important in an animal toy likely to be grasped with an animal's teeth.

The holes in the skeletal structure must be of sufficient size to allow the mold to be extracted from the skeletal structure after forming on that mold, yet the holes must not be so large to interfere with the rolling capability of the skeletal structure. The elastomeric quality of the natural rubber used for the skeletal structure will also allow compression of the skeletal structure during shipment to enable more skeletal structures to be packed into a smaller space than would otherwise be possible.

### BRIEF DESCRIPTION OF THE DRAWINGS

FIG. 1 is a plan view of the first embodiment of the invention.

FIG. 2 is an elevation view for the first embodiment of the invention.

FIG. 3 is a perspective view of the first embodiment of the invention.

FIG. 4 is a plan view of a second embodiment of the invention, an elevation view of a second embodiment of the invention being identical to the plan view.

FIG. 5 is a perspective view of the second embodiment of the invention.

FIG. 6 is an elevation view of a third embodiment of the invention.

FIG. 7 is a plan view of the third embodiment of the invention.

FIG. 8 is a perspective view of the third embodiment of the invention.

FIG. 9 is an elevation view of the fourth embodiment of the invention rotated by 90° counterclockwise.

FIG. 10 is a plan view of the fourth embodiment of the invention.

FIG. 11 is a perspective view of the fourth embodiment of the invention.

FIG. 12 is a front elevation view of the fifth embodiment of the invention.

FIG. 13 is a side elevation view of the fifth embodiment of the invention.

FIG. 14 is a perspective view of the fifth embodiment of the invention.

FIG. 15 is an elevation view of a plurality of specimens of the fifth embodiment of the invention stacked and compressed together for shipping.

FIG. 16 is a front elevation view of the sixth embodiment of the invention.

FIG. 17 is a side elevation view of the sixth embodiment of the invention.

FIG. 18 is a perspective view of the sixth embodiment of the invention.

FIG. 19 is an elevation view of a plurality of specimens of the sixth embodiment of the invention stacked and compressed together for shipping purposes.

FIG. 20 is an elevation view of a seventh embodiment of the invention.

FIG. 21 is a side view of the seventh embodiment of the invention.

FIG. 22 is a perspective view of the seventh embodiment of the invention.

### DETAILED DESCRIPTION OF THE PREFERRED EMBODIMENT

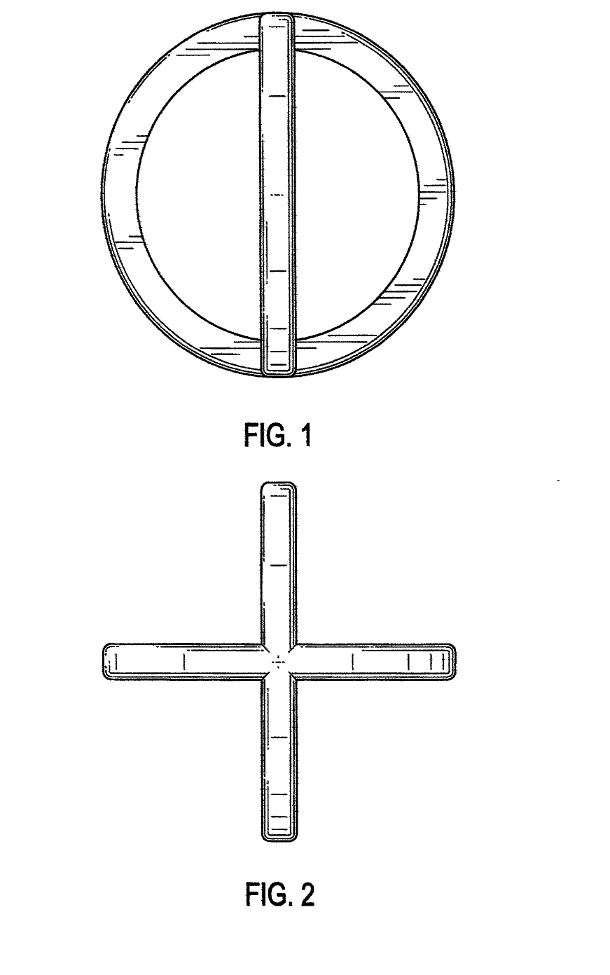

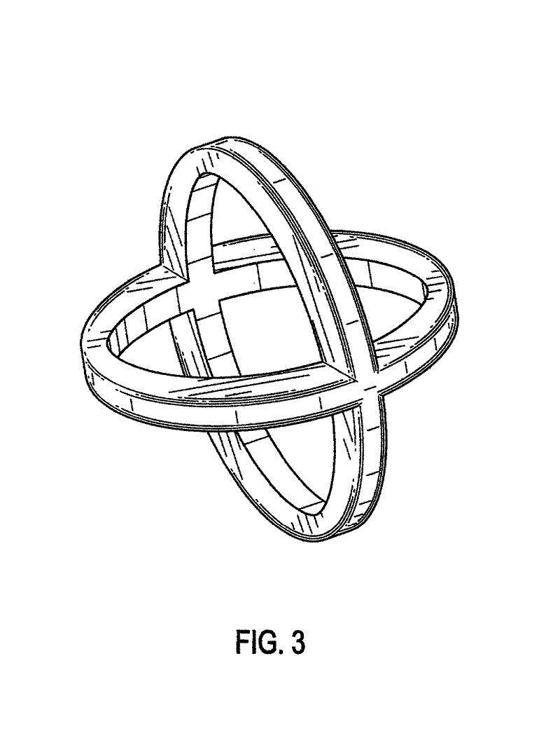

FIGS. 1, 2, and 3 show views of the first embodiment of the invention. The first embodiment of the invention comprises two torii of natural rubber attached to each other at right angles. The torii are of equal diameter which can be enclosed within a spherical surface of equal diameter. The proportion of the area of such a spherical surface occupied by the spaces between the torii, however, may impede easy rolling of the animal toy.

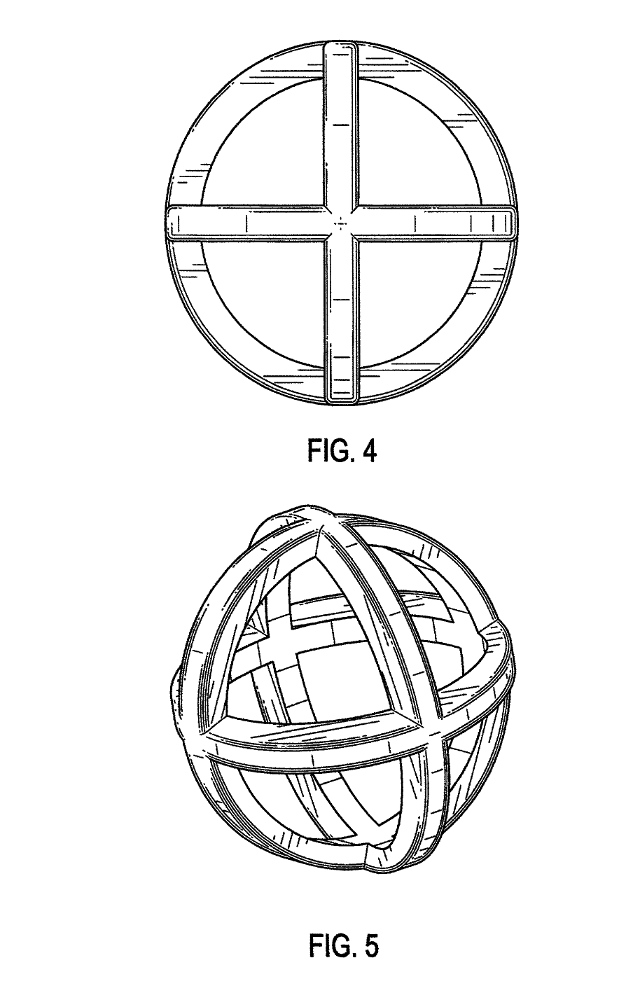

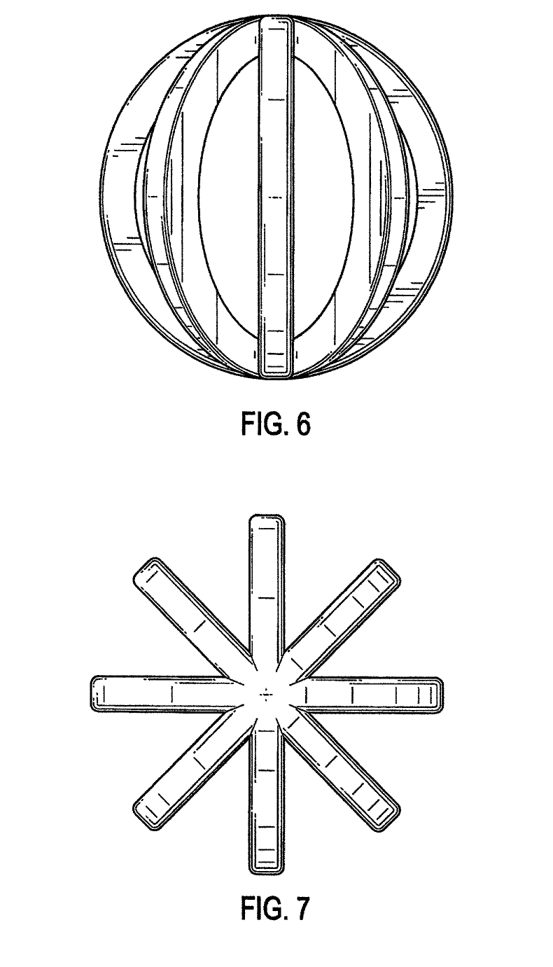

The second embodiment of the invention, shown in FIGS. 4 and 5, differs from the first embodiment of the invention in that it adds yet a third torus set at right angles to both the first and second torii. All three torii are of equal diameter, and can be enclosed within a spherical surface of equal diameter. The total area of the spaces between adjacent torii is a smaller proportion of the surface area of the spherical surface within which the torii can be enclosed than the analogous proportion for the total area of the spaces between the torii of the first embodiment of the invention. Thus, the second embodiment of the invention should roll more easily than the first embodiment of the invention.

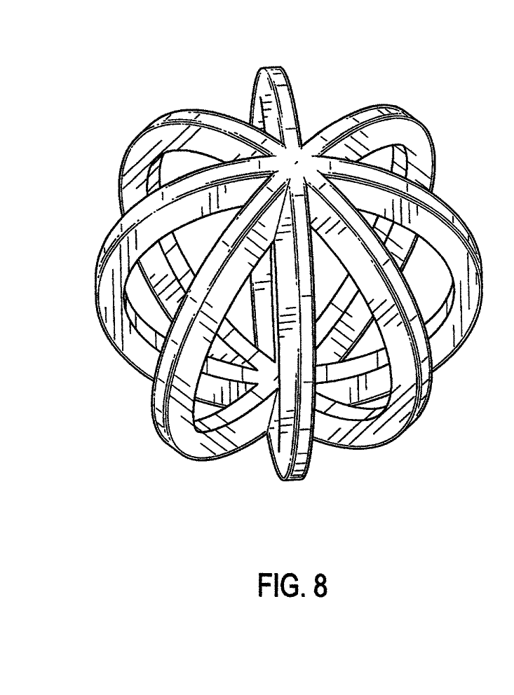

The third embodiment of the invention is shown in FIGS. 6, 7, and 8. The third embodiment of the invention differs from the first embodiment of the invention in that, instead of two intersecting torii being present, four intersecting torii are present, with each intersecting torus being aligned at an angle of forty-five degrees to the adjacent torus. Since all intersecting torii are of equal diameter, the intersecting torii can be inscribed on the surface of a sphere of equal diameter, similarly to the first embodiment of the invention. However, since there are four intersecting torii instead of two as in the first embodiment, the proportion of the surface area of the sphere occupied by the spaces between the torii is smaller than that in the first embodiment. The smaller proportion of surface area occupied by spaces between adjacent torii allows improved rolling ability over the rolling ability present with the first embodiment of the invention.

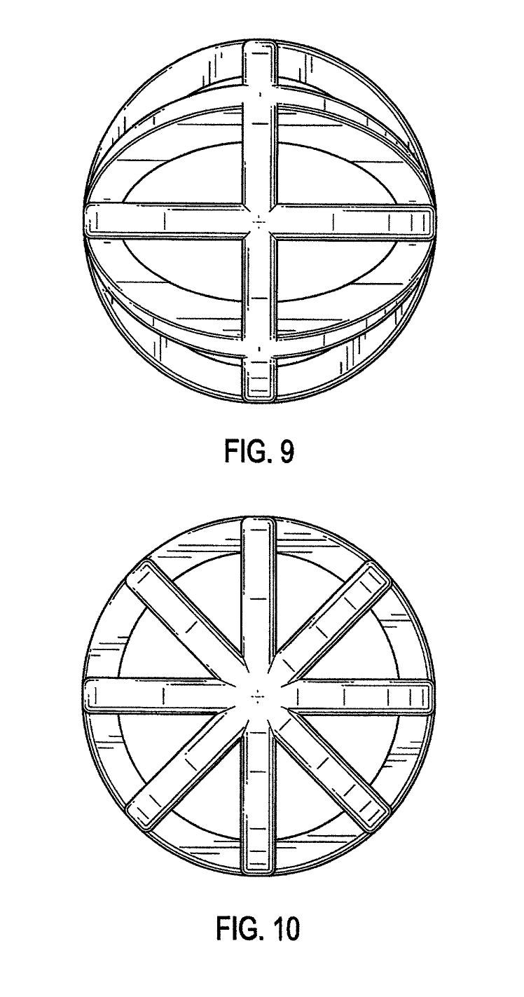

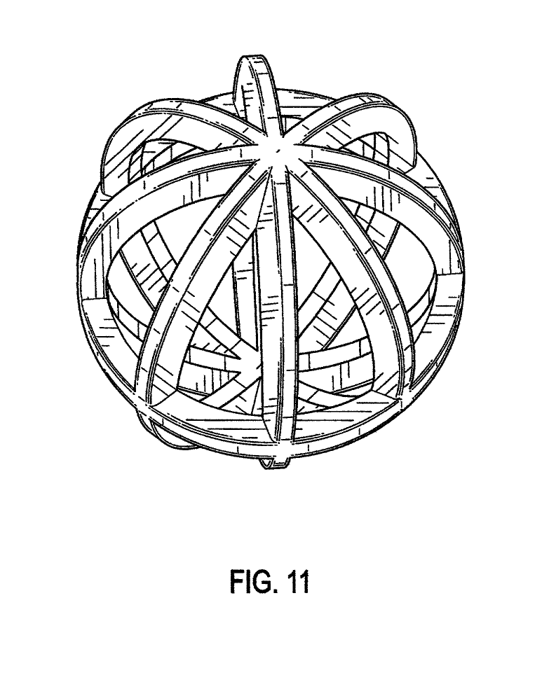

FIGS. 9, 10, and 11 show a fourth embodiment of the invention. The fourth embodiment of the invention differs from the third embodiment of the invention in that an additional torus is added to the four torii at the middle of the diameter of the four torii and in a plane perpendicular to the plane of each of the four torii. The addition of the fifth torus in the fourth embodiment of the invention, when compared to the third embodiment of the invention, allows the fourth embodiment of the invention to roll with greater ease than the third embodiment of the invention.

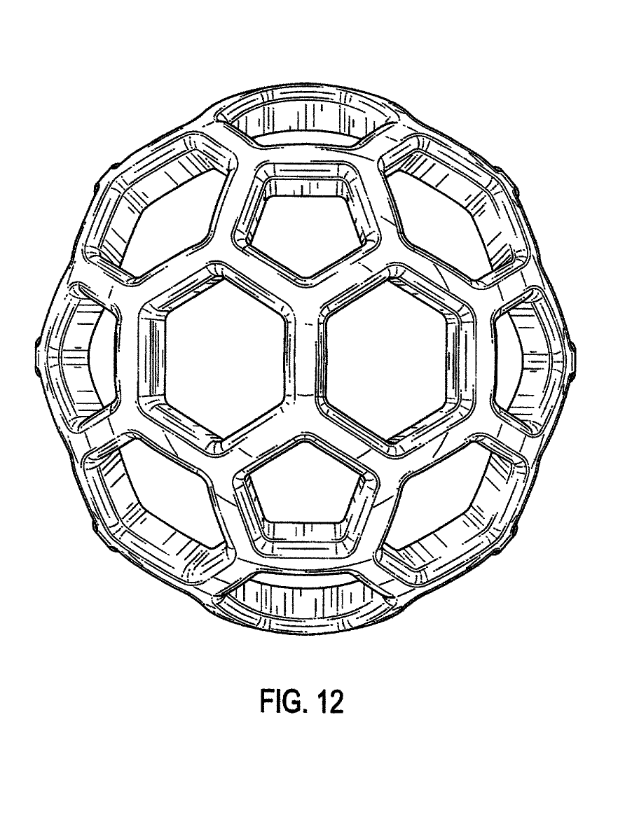

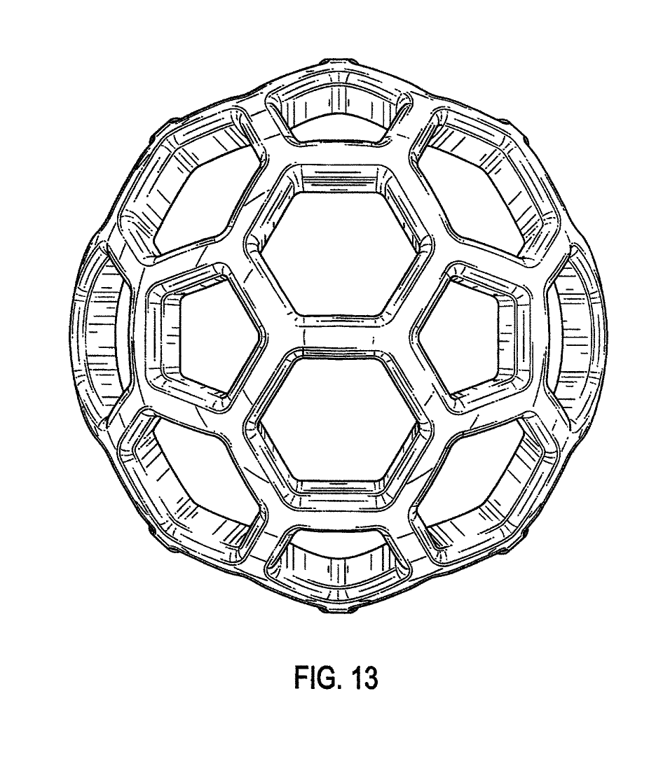

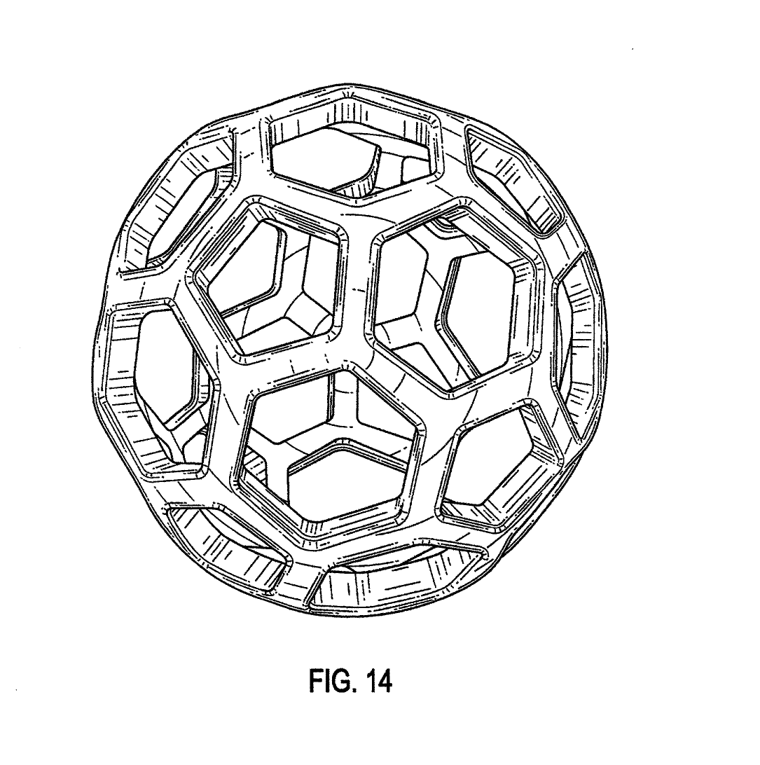

FIGS. 12-15 show a fifth embodiment of the invention. This embodiment of the invention comprises an elastomeric material formed in a skeletal structure to approximate the vertices and edges of a truncated icosahedron which is the chemical structure for a recently discovered form of carbon molecule known as Buckministerfullerine or a “buckyball” for short. It can be seen from FIGS. 12-14 that the holes in the skeletal structure comprise both hexagons and pentagons.

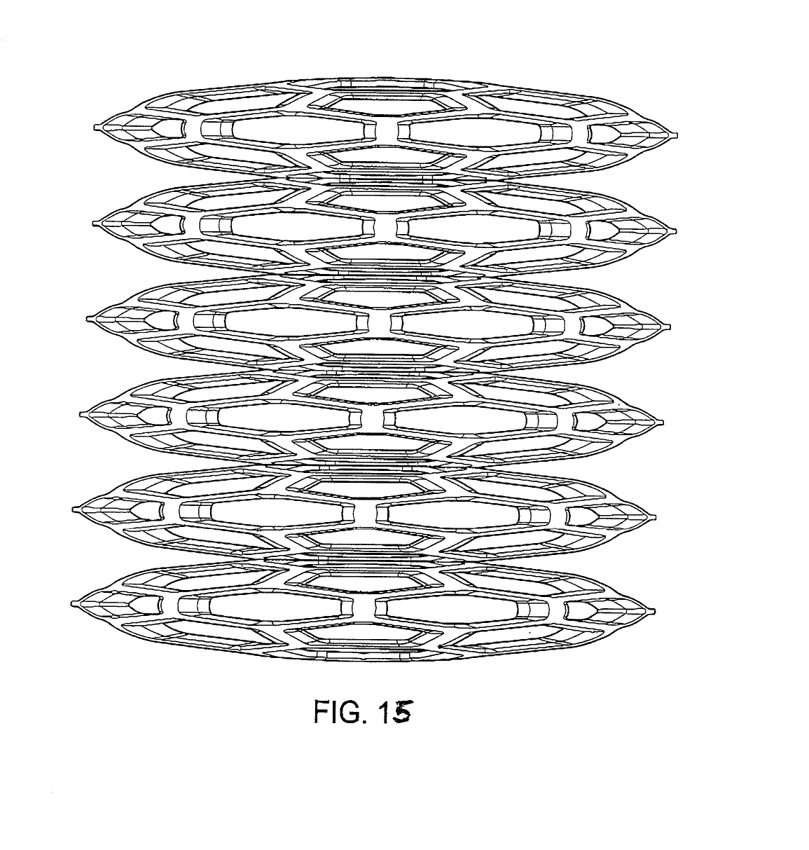

FIG. 15 shows the configuration of several animal toys compressed together for shipping. Since the invention is made of elastomeric rubber, such compression for shipping is fully possible and quite desirable from the standpoint of economy and efficiency. The skeletal structure of the fifth embodiment of the invention in the form of Buckministerfullerine is merely one polyhedron that can be used as a skeletal structure to form the animal toy of the invention.

Other polyhedral surfaces, the vertices of which can be inscribed on a spherical surface, would also be possible candidates to supply the vertices and edges of a skeletal structure for the inventive animal toy. Incidentally, a polyhedral surface is defined as the surface bounding a three dimensional object where such surface is bounded by polygons, each edge of the polyhedral surface being shared by exactly two polygons. However, practically speaking, a polyhedron such as a tetrahedron bounded by four equal equilateral triangles, a hexahedron or cube bounded by six squares and an octahedron bounded by eight equilateral triangles would not be preferable for use as an animal toy of the present invention. For such polyhedra, their ability to roll would be compromised by their relatively nonspherical shape characterized by the distance between their respective faces and the spherical surface on which the vertices of those faces can be inscribed. The dodecahedron, having twelve regular pentagons as faces, and the icosahedron, having twenty equilateral triangles as faces, would be more acceptable polyhedral surfaces to provide vertices and edges for the skeletal structure of the current invention. A polyhedron with more than twenty faces whose vertices can be inscribed on the surface of a sphere would be even more preferable since, as the number of faces of the polyhedron increases, the faces will more closely approximate the spherical surface on which the vertices of the polyhedron can be inscribed. of course, if the vertices of the polyhedron lie on the surface of an ellipsoid given by the equation:

$$\frac{{x}^{2}}{{a}^{2}} + \frac{{y}^{2}}{{b}^{2}} + \frac{{z}^{2}}{{c}^{2}} = 1$$

where “a”, “b”, and “c” are approximately equal to 1, the rolling capacity of the skeletal structure should not be significantly adversely affected.

A collection of numerous polyhedra can be found on the internet at www.georgehart.com/virtual-polyhedra/vp.html. In addition, a website entitled “The Pavilion of Polyhedreality” contains a listing and links to other websites related to polyhedra. The Pavilion of Polyhedreality may be found at www.georgehart.com/pavilion.html.

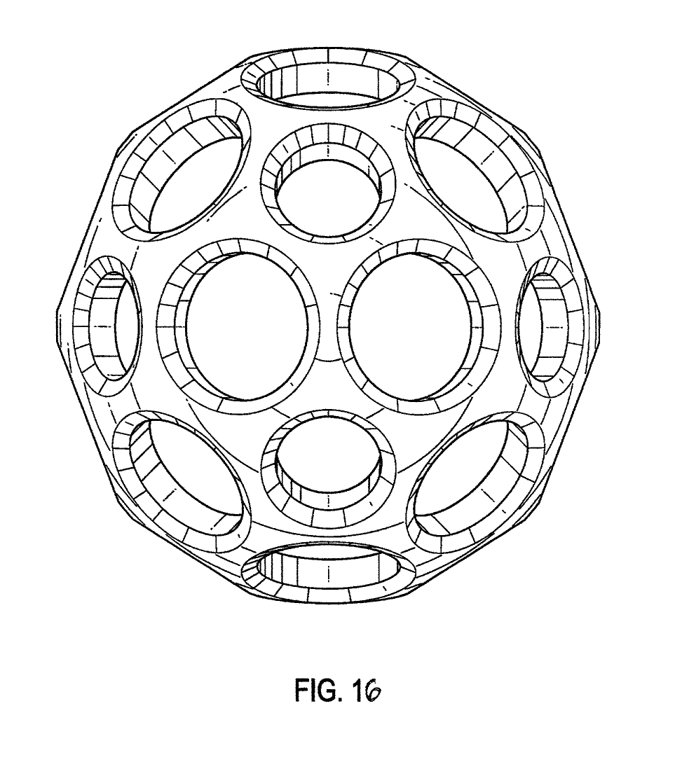

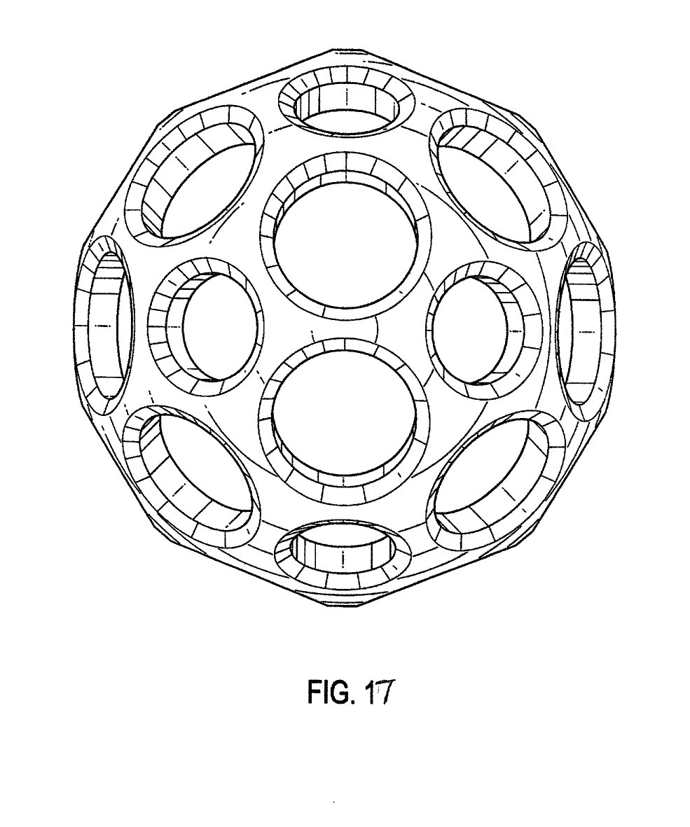

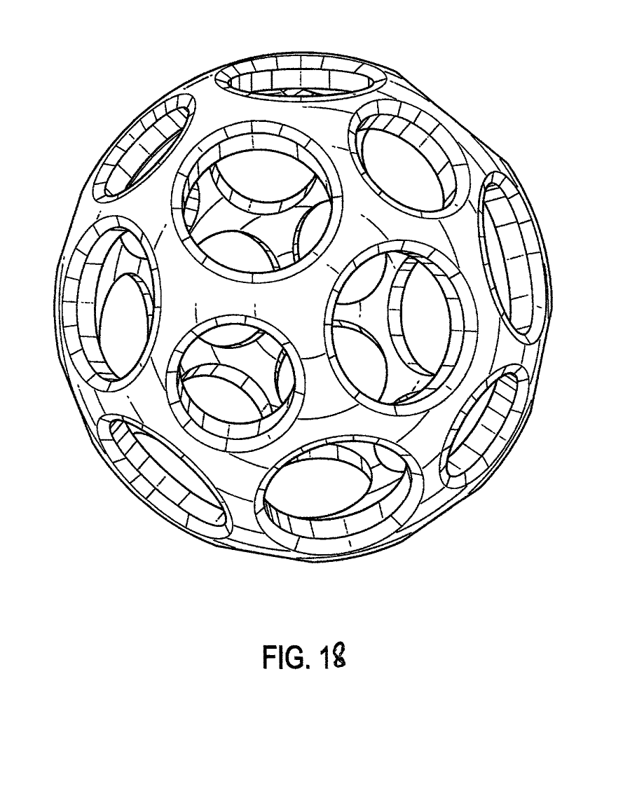

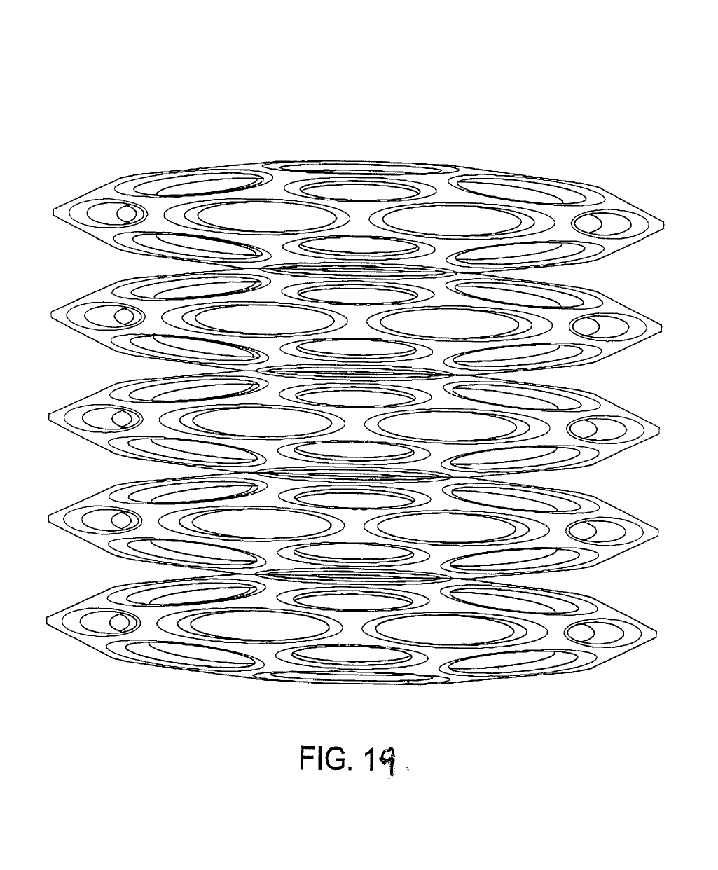

The sixth embodiment of the invention is shown in FIGS. 16-19. It differs from the fifth embodiment of the invention, in that, although the outer surfaces of the skeletal structure are faces of a polyhedral surface, instead of the holes cut in the skeletal structure being in the shape of the faces themselves, circular holes are cut in each face instead.

FIG. 19 shows a series of skeletal structures of the sixth embodiment of the invention compressed for shipping, similar to FIG. 15. of course, other shapes of infinite variety may be cut as holes in the polyhedral faces of the skeletal structure besides circular holes as shown in FIG. 19.

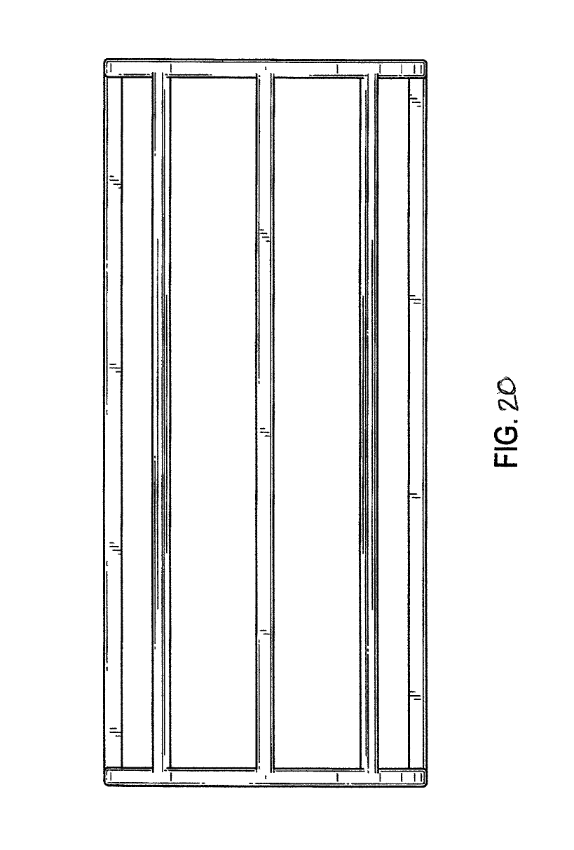

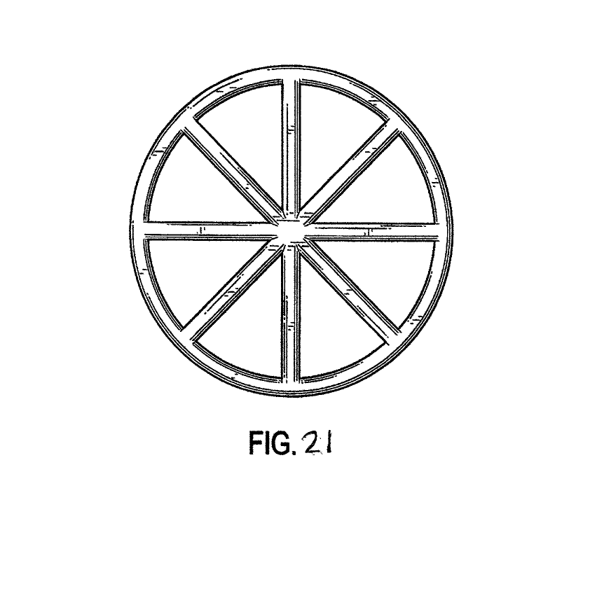

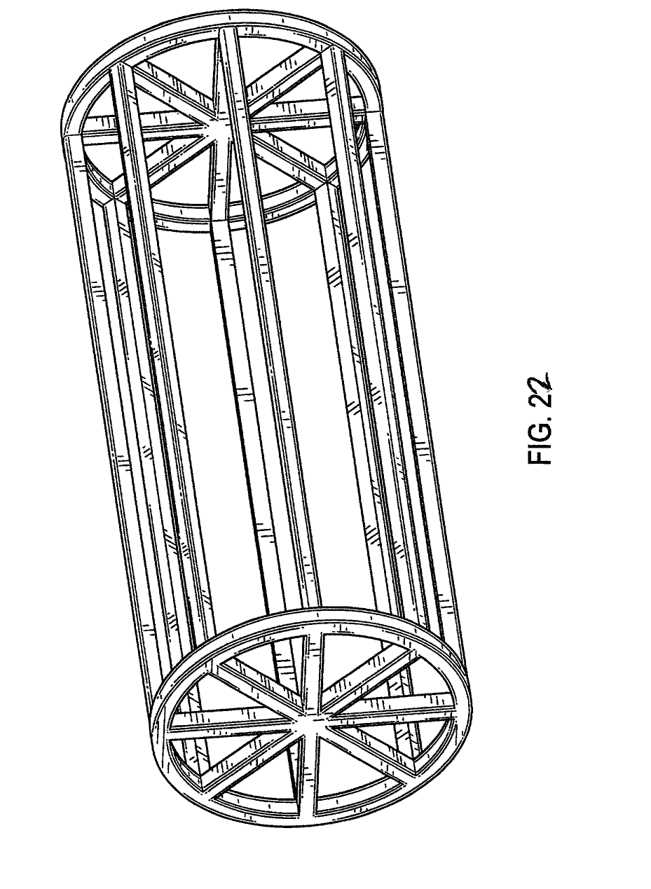

FIGS. 20-22 show a seventh embodiment of the invention. These drawings show a cylindrical skeletal structure for the animal toy with the two ends of the cylinder being closed by a spoke arrangement of such skeletal structure. Although a cylinder typically has a circular cross-section, a cylinder with an elliptical cross-section may also be considered provided that the eccentricity of the ellipse is kept low enough so that the shape of the ellipse does not interfere with the ease of rolling the skeletal cylindrical structure.

The holes in all of the skeletal structures of the present invention must be large enough so that the internal molds on which they are formed can be extracted from the skeletal structure after forming. In addition, the holes should be large enough so that an animal can grasp the skeletal structure easily with its teeth. The holes, however, should not be so large that they are within faces large enough to significantly flatten the skeletal structure and thus interfere with the ease of rolling the skeletal structure.

For example, samples of the fifth embodiment of the invention in the buckyball configuration have been produced. For a sample of approximate diameter of 4⅝ inches, a maximum dimension of the holes was approximately 1½ inches and a minimum dimension of the holes was approximately ¾ of an inch. A second sample in the buckyball configuration of approximately 5½ inches in diameter was also produced. For that second sample, the maximum dimension of the holes was approximately ¾ inches, while the minimum dimension of the holes was approximately ¾ of an inch. Finally, a sample in the buckyball configuration of approximately 7⅛ inch diameter was produced. For that sample, a maximum dimension of the holes of approximately 2½ inches was measured, while a minimum dimension of the holes of approximately 1⅛ inches was measured. In general, dimensions of the holes for the buckyballs should be in the range from ⅜ of an inch to 4 inches and the range of diameters for the buckyballs should be 3 to 14 inches.

The preferred material for the animal toy of the present invention is natural rubber since that elastomeric material, in addition to its capability of bouncing which synthetic elastomeric materials also possess, allows the extraction of an internal mold through one of the holes of the skeletal structure when the skeletal structure has just been formed and is still in a heated state. Synthetic elastomeric materials may not allow an internal mold to be extracted from a skeletal structure formed of such synthetic elastomeric materials when such skeletal structure is still in a heated state. Furthermore, natural rubber has superior tear resistance to synthetic elastomers which is important in an animal toy where the animal can be expected to grasp the toy with its teeth. The material of the animal toy, in general, has the following composition: 90% natural rubber, 2% calcium carbonate, 1% sulfur, 5% accelerator combination and 2% zinc oxide.

Natural rubber, known chemically as cis-polyisoprene, is from a plant source most often from the tree Hevea Brasiliensis. However, rubber is also available from chemical synthesis and is then known as synthetic natural rubber and is known chemically as polyisoprene. With regard to the important properties of cold tear resistance to resist tearing by an animal's teeth, hot tear resistance to allow extraction of a mold, and resilience necessary for this animal toy, synthetic natural rubber is the equivalent of natural rubber. In addition, although the composition of the animal toy given above has 90% natural rubber, it is not necessary for 90% of the animal toy to be natural rubber. Natural rubber or synthetic natural rubber can be blended with other polymers and still make possible the necessary properties of the animal toy. However, the natural rubber or synthetic rubber in such a blend would still have to be more than 50% of the polymer in the compound. Thus, assuming a normal 90% natural rubber composition of the animal toy, natural rubber would have to be more than 45% of the animal toy with another less than 45% of the animal toy being another polymer blended with natural rubber or synthetic natural rubber. Such blending polymers include butadiene rubber, styrene-butadiene rubber, nitrile rubber, ethylene-propylene-diene-monomer (EPDM)rubber or other sulfur vulcanizable elastomeric polymers that would be known to one of ordinary skill in the art.

The calcium carbonate in the above composition, which is most often ground limestone, and is also known as Whiting, is used to make the rubber product opaque instead of translucent or mottled in hue. More expensive substitutes for calcium carbonate include various types of clay or talc such as diatomaceous earth, aluminum silicate, also known as clay, magnesium aluminum silicate, and magnesium carbonate.

Sulfur in the above composition acts to form chemical crosslinks in the natural rubber or synthetic natural rubber in a process known as vulcanization. Peroxides could also be used to vulcanize the natural rubber or synthetic natural rubber, but then the properties of hot and cold tear resistance and resilience would not be as good as those obtained with a sulfur based vulcanization process.

The zinc oxide in the above composition catalyzes the vulcanization reaction. Substitutes for zinc oxide are cadmium oxide and lead oxide, but they are more costly than zinc oxide and are also considered hazardous. An additional catalyst is often used in combination with the zinc oxide, the additional catalyst being a fatty acid, stearic acid being the most often used fatty acid. Instead of the combination of the zinc oxide and the fatty acid, a zinc salt, such as zinc stearate, may be used as a catalyst also.

The accelerator combination is a group of chemicals which increase the speed of the vulcanization process of the rubber. The principal types of accelerators are derivatives of Schiff's bases; and include the following families of compounds: guanidines, thiazoles, sulfenamides, thiocarbamates, thiurams, zimates, and morpholines. One of ordinary skill in the art would be aware of the particular subvarieties within each family and how to combine them.

Finally, if any one of butadiene rubber, neoprene, known chemically as polychloroprene, or EPDM rubber is reinforced with carbon black and used instead of synthetic natural rubber or natural rubber, the resulting animal toys will have hot and cold tear resistance and resilience approaching that available with either natural rubber or synthetic natural rubber. However, all such animal toys will be black due to the presence of carbon black, as contrasted to animal toys using natural rubber or synthetic natural rubber or other gum compounds including natural rubber or synthetic natural rubber and including no carbon black, which can be dyed to any desired color.

The animals contemplated to use this toy the most are dogs, although cats and other pets attracted to rolling objects may also be amused by it.

What is claimed is:

1. A skeletal animal toy with a certain skeletal structure, said skeletal animal toy at least being capable of rolling and bouncing.

2. A skeletal animal toy as claimed in claim 1, including elastomeric material.

3. A skeletal animal toy as claimed in claim 2, wherein said elastomeric material is natural rubber.

4. A skeletal animal toy as claimed in claim 2, wherein said elastomeric material is synthetic natural rubber.

5. A skeletal animal toy as claimed in claim 2, wherein said elastomeric material is a combination of natural rubber and one of a group of blending polymers consisting of butadiene rubber, styrene-butadiene rubber, nitrile rubber, and ethylene-propylene-diene-monomer rubber.

6. A skeletal animal toy as claimed in claim 2, wherein said elastomeric material is a combination of synthetic natural rubber and one of a group of blending polymers consisting of butadiene rubber, styrene-butadiene rubber, nitrile rubber, and ethylene-propylene-diene-monomer rubber.

7. A skeletal animal toy as claimed in claim 2, wherein said elastomeric material is one of a group of polymers consisting of butadiene rubber, neoprene and ethylene-propylene-diene-monomer rubber, said polymer being reinforced with carbon black.

8. A skeletal animal toy as claimed in claim 2, wherein said elastomeric material has sufficient hot tear resistance to allow an internal mold to be extracted through a hole of said certain skeletal structure without tearing said certain skeletal structure.

9. A skeletal animal toy as claimed in claim 3, further including calcium carbonate.

10. A skeletal animal toy as claimed in claim 3, further including sulfur.

11. A skeletal animal toy as claimed in claim 10, further including zinc oxide.

12. A skeletal animal toy as claimed in claim 11, further including a fatty acid.

13. A skeletal animal toy as claimed in claim 10, further including a zinc salt.

14. A skeletal animal toy as claimed in claim 10, further including an accelerator combination.

15. A skeletal animal toy as claimed in claim 4, further including calcium carbonate.

16. A skeletal animal toy as claimed in claim 4, further including sulfur.

17. A skeletal animal toy as claimed in claim 16, further including zinc oxide.

18. A skeletal animal toy as claimed in claim 17, further including a fatty acid.

19. A skeletal animal toy as claimed in claim 16, further including a zinc salt.

20. A skeletal animal toy as claimed in claim 16, further including an accelerator combination.

21. A skeletal animal toy as claimed in claim 1, wherein said certain skeletal structure comprises at least two torii of equal diameter.

22. A skeletal animal toy as claimed in claim 1, wherein said certain skeletal structure comprises the approximate vertices and edges of a truncated icosahedron.

23. A skeletal animal toy as claimed in claim 1, wherein said certain skeletal structure comprises two torii of equal diameter, said two torii being separated by a certain lateral distance, at least two linear members spanning said certain lateral distance, and at least one linear member for each of said two torii, said at least one linear member spanning said equal diameter of said each of said two torii.

24. A skeletal animal toy as claimed in claim 1, wherein said certain skeletal structure comprises two ellipses separated by a certain lateral distance, at least two linear members spanning said certain lateral distance, and at least one linear member for each of said two ellipses, said at least one linear member spanning said each of said two ellipses.

25. A skeletal animal toy as claimed in claim 1, wherein at least a portion of each member of said certain skeletal structure lies on an imaginary spherical surface.

26. A skeletal animal toy as claimed in claim 1, wherein at least a portion of each member of said certain skeletal structure lies on an imaginary ellipsoidal surface.
